(19) United States
(12) Patent Application Publication
(10) Pub. No.: US 2011/0241531 A1
(43) Pub. Date: Oct. 6, 2011

(54) Light Emitting Diode Whose Light is Distributed Evenly

(76) Inventor: Ming-Tsai Wang, Kaohsiung County (TW)

(21) Appl. No.: 12/754,852

(22) Filed: Apr. 6, 2010

(51) Int. Cl. H01J 5/50

(52) U.S. Cl. 313/318.05

(57) ABSTRACT

A light emitting diode includes a packing housing, a negative pole and a positive pole. The packing housing has a surface provided with a first arc-shaped portion and a second arc-shaped portion having a radian different from that of the first arc-shaped portion. Thus, the first arc-shaped portion and the second arc-shaped portion of the packing housing form a double diffusion effect to the light passing through the packing housing so that the light emitted outwardly from the packing housing is distributed evenly without producing a concentration of light so as to enhance the brightness of the light emitting diode. In addition, the light emitted outwardly from the packing housing is diffused by the first arc-shaped portion and the second arc-shaped portion so that the packing housing has a better heat radiating effect.

### BACKGROUND OF THE INVENTION

1. Field of the Invention

The present invention relates to a lighting member and, more particularly, to a light emitting diode that emits light outwardly to provide an illuminating effect.

2. Description of the Related Art

A conventional light emitting diode 10 in accordance with the prior art shown in FIG. 6 comprises a packing housing 11, a negative pole 12 mounted on the packing housing 11, and a positive pole 13 mounted on the packing housing 11. The packing housing 21 has an upper end provided with a semi-spherical portion 111 and a lower end provided with a cylindrical portion 112. The packing housing 11 has a bottom 14 which has a substantially circular shape. The packing housing 11 has a height “H1”. The bottom 14 of the packing housing 11 has a diameter “D1”. Each of the negative pole 12 and the positive pole 13 has an upper end packed in the packing housing 11 so that the negative pole 12 and the positive pole 13 are protected by the packing housing 11. Thus, when an electric current passes through the negative pole 12 and the positive pole 13, a light is produced and is emitted outwardly from the packing housing 11. However, most of the light is emitted outwardly from the semi-spherical portion 111 of the packing housing 11, and only a little light is emitted outwardly from the cylindrical portion 112 of the packing housing 11, so that the light emitted outwardly from the packing housing 11 is not evenly distributed, thereby decreasing the brightness of the light emitting diode 10. In addition, the light is mainly concentrated on the semi-spherical portion 111 of the packing housing 11 to produce a concentration of light, so that a greater heat is concentrated on the semi-spherical portion 111 of the packing housing 11, thereby causing a heat dissipation problem.

### BRIEF SUMMARY OF THE INVENTION

In accordance with the present invention, there is provided a light emitting diode, comprising a packing housing, a negative pole mounted on the packing housing, and a positive pole mounted on the packing housing. The packing housing has a surface provided with a first arc-shaped portion and a second arc-shaped portion having a radian different from that of the first arc-shaped portion.

The primary objective of the present invention is to provide a light emitting diode whose light is distributed evenly and smoothly to enhance its brightness.

Another objective of the present invention is to provide a light emitting diode, wherein the first arc-shaped portion and the second arc-shaped portion of the packing housing form a double diffusion effect to the light passing through the packing housing so that the light emitted outwardly from the packing housing is distributed evenly without producing a concentration of light so as to enhance the brightness of the light emitting diode.

A further objective of the present invention is to provide a light emitting diode, wherein the light emitted outwardly from the packing housing is diffused and distributed evenly and smoothly by the first arc-shaped portion and the second arc-shaped portion of the packing housing so that the packing housing has a better heat radiating effect so as to enhance the lifetime of the light emitting diode.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front view of a light emitting diode in accordance with a first preferred embodiment of the present invention.

FIG. 2 is a front view of a light emitting diode in accordance with a second embodiment of the present invention.

FIG. 3 is a front view of a light emitting diode in accordance with a third preferred embodiment of the present invention.

FIG. 4 is a front view of a light emitting diode in accordance with a fourth preferred embodiment of the present invention.

FIG. 5 is a front view of a light emitting diode in accordance with fifth preferred embodiment of the present invention.

FIG. 6 is a front view of a conventional light emitting diode in accordance with the prior art.

### DETAILED DESCRIPTION OF THE INVENTION

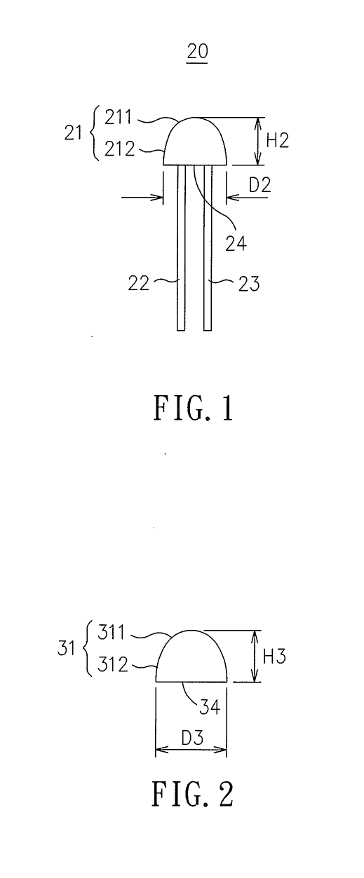

Referring to the drawings and initially to FIG. 1, a light emitting diode 20 in accordance with the preferred embodiment of the present invention comprises a packing housing 21, a negative pole 22 mounted on the packing housing 21, and a positive pole 23 mounted on the packing housing 21.

The packing housing 21 is made of a plastic material and is formed by a plastic injection molding process. The packing housing 21 has a surface provided with a first arc-shaped portion 211 and a second arc-shaped portion 212 having a radian different from that of the first arc-shaped portion 211. Preferably, the second arc-shaped portion 212 of the packing housing 21 has a radian greater than that of the first arc-shaped portion 211. The packing housing 21 has a bottom 24 which has a substantially circular shape. The first arc-shaped portion 211 of the packing housing 21 is located at a top of the packing housing 21. The second arc-shaped portion 212 of the packing housing 21 connects the first arc-shaped portion 211. The second arc-shaped portion 212 of the packing housing 21 is located between the first arc-shaped portion 211 and the bottom 24 of the packing housing 21. The packing housing 21 has a height “H2”. The bottom 24 of the packing housing 21 has a diameter “D2”.

In the preferred embodiment of the present invention, the packing housing 21 has a height “H2” equal to 6.50 mm, the bottom 24 of the packing housing 21 has a diameter “D2” equal to 8.0 mm, the first arc-shaped portion 211 of the packing housing 21 has a radius equal to 3.50 mm, and the second arc-shaped portion 212 of the packing housing 21 has a radius equal to 10.37 mm. It is appreciated that, the height “H2” of the packing housing 21, the diameter “D2” of the bottom 24 of the packing housing 21, the radius of the first arc-shaped portion 211 of the packing housing 21 and the radius of the second arc-shaped portion 212 of the packing housing 21 are designed and determined according to the practical requirement.

Each of the negative pole 22 and the positive pole 23 has an upper end packed in the packing housing 21 so that the negative pole 22 and the positive pole 23 are protected by the packing housing 21. Thus, when an electric current passes through the negative pole 22 and the positive pole 23, a light is produced and is emitted outwardly from the packing housing 21.

Accordingly, the first arc-shaped portion 211 and the second arc-shaped portion 212 of the packing housing 21 form a double diffusion effect to the light passing through the packing housing 21 so that the light emitted outwardly from the packing housing 21 is distributed evenly without producing a concentration of light so as to enhance the brightness of the light emitting diode 20. In addition, the light emitted outwardly from the packing housing 21 is diffused and distributed evenly and smoothly by the first arc-shaped portion 211 and the second arc-shaped portion 212 of the packing housing 21 so that the packing housing 21 has a better heat radiating effect so as to enhance the lifetime of the light emitting diode 20.

Referring to FIG. 2, the packing housing 31 has a height “H3” equal to 6.50 mm, the bottom 34 of the packing housing 31 has a diameter “D3” equal to 9.0 mm, the first arc-shaped portion 311 of the packing housing 31 has a radius equal to 3.84 mm, and the second arc-shaped portion 312 of the packing housing 31 has a radius equal to 7.76 mm.

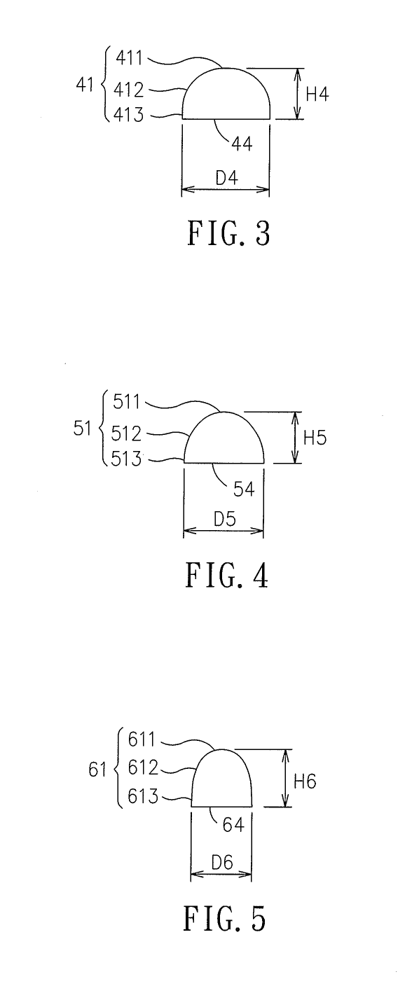

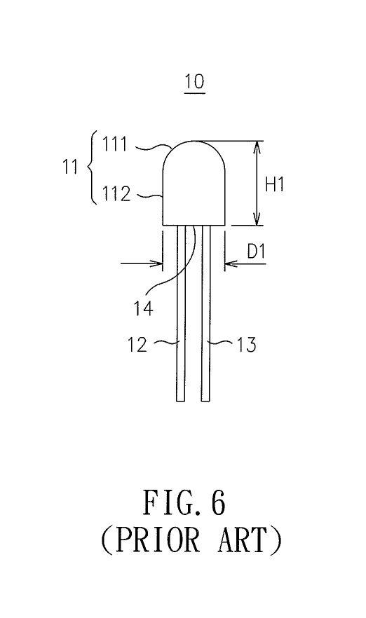

Referring to FIG. 3, the surface of the packing housing 41 is further provided with a cylindrical portion 413. The cylindrical portion 413 of the packing housing 41 connects the second arc-shaped portion 412. The second arc-shaped portion 412 of the packing housing 41 is located between the first arc-shaped portion 411 and the cylindrical portion 413, and the cylindrical portion 413 of the packing housing 41 is located between the second arc-shaped portion 412 and the bottom 44 of the packing housing 41. In addition, the packing housing 41 has a height “H4” equal to 6.50 mm, the bottom 44 of the packing housing 41 has a diameter “D4” equal to 11.00 mm, the first arc-shaped portion 411 of the packing housing 41 has a radius equal to 5.00 mm, and the second arc-shaped portion 412 of the packing housing 41 has a radius equal to 5.15 mm.

Referring to FIG. 4, the surface of the packing housing 51 is further provided with a cylindrical portion 513. In addition, the packing housing 51 has a height “H5” equal to 6.50 mm, the bottom 44 of the packing housing 51 has a diameter “D5” equal to 10.00 mm, the first arc-shaped portion 511 of the packing housing 51 has a radius equal to 4.11 mm, and the second arc-shaped portion 512 of the packing housing 51 has a radius equal to 6.75 mm.

Referring to FIG. 5, the surface of the packing housing 61 is further provided with a third arc-shaped portion 613. The third arc-shaped portion 613 of the packing housing 61 connects the second arc-shaped portion 612. The second arc-shaped portion 612 of the packing housing 61 is located between the first arc-shaped portion 611 and the third arc-shaped portion 613 of the packing housing 61, and the third arc-shaped portion 613 of the packing housing 61 is located between the second arc-shaped portion 612 and the bottom 64 of the packing housing 61. The third arc-shaped portion 613 of the packing housing 61 has a radian different from that of the first arc-shaped portion 611 and the second arc-shaped portion 612. Preferably, the second arc-shaped portion 612 of the packing housing 61 has a radian greater than that of the first arc-shaped portion 611, and the third arc-shaped portion 613 of the packing housing 61 has a radian greater than that of the second arc-shaped portion 612. In addition, the packing housing 61 has a height “H6” equal to 7.25 mm, the bottom 64 of the packing housing 61 has a diameter “D6” equal to 7.64 mm, the first arc-shaped portion 611 of the packing housing 61 has a radius equal to 3.24 mm, the second arc-shaped portion 612 of the packing housing 61 has a radius equal to 7.68 mm, and the third arc-shaped portion 613 of the packing housing 61 has a radius equal to 35.40 mm.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A light emitting diode, comprising:
a packing housing;
a negative pole mounted on the packing housing;
a positive pole mounted on the packing housing;
wherein the packing housing has a surface provided with a first arc-shaped portion and a second arc-shaped portion having a radian different from that of the first arc-shaped portion.

2. The light emitting diode of claim 1, wherein the second arc-shaped portion of the packing housing has a radian greater than that of the first arc-shaped portion.

3. The light emitting diode of claim 1, wherein the second arc-shaped portion of the packing housing connects the first arc-shaped portion.

4. The light emitting diode of claim 3, wherein
the packing housing has a bottom;
the first arc-shaped portion of the packing housing is located at a top of the packing housing;
the second arc-shaped portion of the packing housing is located between the first arc-shaped portion and the bottom of the packing housing.

5. The light emitting diode of claim 4, wherein the bottom of the packing housing has a substantially circular shape.

6. The light emitting diode of claim 1, wherein the surface of the packing housing is further provided with a cylindrical portion.

7. The light emitting diode of claim 6, wherein the cylindrical portion of the packing housing connects the second arc-shaped portion.

8. The light emitting diode of claim 7, wherein
the packing housing has a bottom;
the second arc-shaped portion of the packing housing is located between the first arc-shaped portion and the cylindrical portion;
the cylindrical portion of the packing housing is located between the second arc-shaped portion and the bottom of the packing housing.

9. The light emitting diode of claim 1, wherein the surface of the packing housing is further provided with a third arc-shaped portion.

10. The light emitting diode of claim 9, wherein the third arc-shaped portion of the packing housing connects the second arc-shaped portion.

11. The light emitting diode of claim 10, wherein
the packing housing has a bottom;
the second arc-shaped portion of the packing housing is located between the first arc-shaped portion and the third arc-shaped portion of the packing housing;
the third arc-shaped portion of the packing housing is located between the second arc-shaped portion and the bottom of the packing housing.

12. The light emitting diode of claim 9, wherein the third arc-shaped portion of the packing housing has a radian different from that of the first arc-shaped portion and the second arc-shaped portion.

13. The light emitting diode of claim 12, wherein
the second arc-shaped portion of the packing housing has a radian greater than that of the first arc-shaped portion;
the third arc-shaped portion of the packing housing has a radian greater than that of the second arc-shaped portion.

14. The light emitting diode of claim 1, wherein the packing housing is made of a plastic material.

15. The light emitting diode of claim 1, wherein the packing housing is formed by a plastic injection molding process.
